(19) United States
(12) Patent Application Publication
(10) Pub. No.: US 2024/0241716 A1
(43) Pub. Date: Jul. 18, 2024

(54) CODE COMPONENT SHARING ACROSS SOFTWARE PRODUCT VERSIONS FOR PRODUCT DEVELOPMENT

(71) Applicant: International Business Machines Corporation, Armonk, NY (US)

(72) Inventors: Darren R. Beard, Chandlers Ford (GB); SHANNA XU, Southampton (GB); Michael John Fish, Eastleigh (GB)

(21) Appl. No.: 18/155,098

(22) Filed: Jan. 17, 2023

(51) Int. Cl. G06F 8/71; G06F 11/36

(52) U.S. Cl. CPC G06F 8/71; G06F 11/3616; G06F 11/3636

(57) ABSTRACT

A method, computer program product, and computer system are provided for code component sharing across software product versions for product development. The method includes configuring one or more shared code components for functions of a first version of a product to be used by a second version of the product for the functions in the second version. The method intercepting a use of a function of the second version equivalent to a function of a shared code component of the first version and routing intercepted use to the shared code component of the first version. The method uses cross-version communication of a shared operating system between the first version and the second version to use the shared code component on the first version for the intercepted use of the function.

### BACKGROUND

The present invention relates generally to software product development, and more particularly to code component sharing across software product versions for product development.

When changes are made to a software product to update it to a newer version during development or maintenance, the changes may cause problems with the software.

These new problems may be so serious that the product fails to initialize properly and fails to produce any useful diagnostic information. These situations can be very hard to debug.

### SUMMARY

According to an embodiment of the present invention there is provided a computer-implemented method for code component sharing across software product versions for product development, said method comprising: configuring one or more shared code components for functions of a first version of a product to be used by a second version of the product for the functions in the second version; intercepting a use of a function of the second version equivalent to a function of a shared code component of the first version; routing intercepted use to the shared code component of the first version; and using cross-version communication of a shared operating system between the first version and the second version to use the shared code component on the first version for the intercepted use of the function.

According to another embodiment of the present invention there is provided a system for code component sharing across software product versions for product development, comprising: a processor and a memory configured to provide computer program instructions to the processor to execute functions of components of a component sharing tool provided on a shared operating system of a first and second version of a software product, the component sharing tool including: a configuration component for configuring one or more shared code components for functions of a first version of a product to be used by a second version of the product for the functions in the second version; an intercepting component for intercepting a use of a function of the second version equivalent to a function of a shared code component of the first version; a routing component for routing intercepted use to the shared code component of the first version; and a cross-version communication component using cross-version communication of a shared operating system between the first version and the second version to use the shared code component on the first version for the intercepted use of the function.

According to a further embodiment of the present invention there is provided a computer program product for code component sharing across software product versions for product development, the computer program product comprising a computer readable storage medium having program instructions embodied therewith, the program instructions executable by a processor to cause the processor to: configure one or more shared code components for functions of a first version of a product to be used by a second version of the product for the functions in the second version; intercept a use of a function of the second version equivalent to a function of a shared code component of the first version; route intercepted use to the shared code component of the first version; and use cross-version communication of a shared operating system between the first version and the second version to use the shared code component on the first version for the intercepted use of the function.

The computer readable storage medium may be a non-transitory computer readable storage medium and the computer readable program code may be executable by a processing circuit.

### BRIEF DESCRIPTION OF THE SEVERAL VIEWS OF THE DRAWINGS

Embodiments of the present invention will now be described, by way of example only, with reference to the accompanying drawings.

FIG. 1 is a block diagram of an example embodiment of a system in accordance with embodiments of the present invention.

FIG. 2 is a flow diagram of an example embodiment of a method in accordance with embodiments of the present invention.

FIG. 3A is a flow diagram of another example embodiment of a method in accordance with embodiments of the present invention.

FIG. 3B is a flow diagram of a further example embodiment of a method in accordance with embodiments of the present invention.

FIG. 4 is block diagram of an example embodiment of a system in accordance with embodiments of the present invention.

FIG. 5 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for code component sharing across software product versions for product development including debugging and fault handling. The system provides a component sharing tool that coordinates the sharing between a first version of a product and a second version of a product such that one of the versions uses code from the other version to perform some functions.

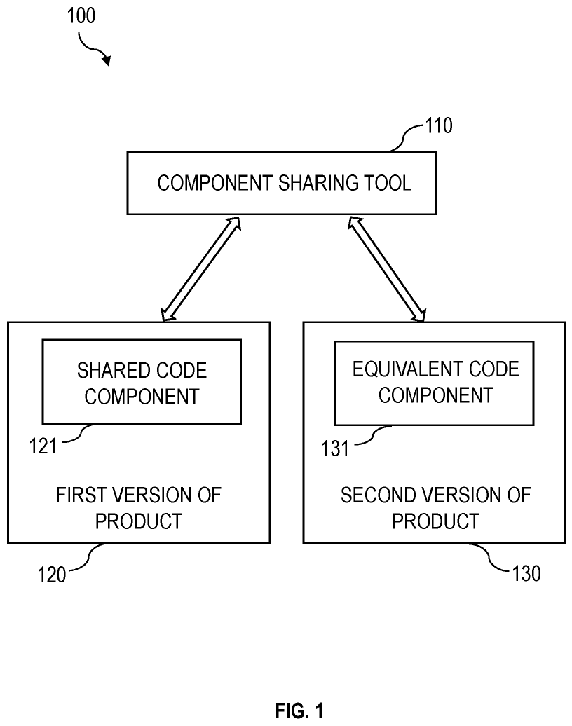

Referring to FIG. 1, a block diagram 100 shows an example environment in which the described method and system may be provided including a first version of a software product 120 and a second version of the software product 130. The first version 120 may have a code component 121 that it shares with the second version 130. In some cases the shared code component 121 may be an equivalent code component to a code component 131 in the second version 130, such as an updated version of the code component 121. In other cases, the equivalent code component may not exist in the second version 130. For example, this may occur in early development of a software product where a first version 120 has code components that are not provided in the second version 130.

The described system provides a component sharing tool 110 for sharing code components 121 between different versions 120 and 130 of a software product. The component sharing tool 110 may be provided separately from the versions 120 and 130 of the software product, for example, in a separate address space. The component sharing tool 110 may be used by any products running functionally separated code components on a same operating system. For example, the software products may be application servers, information management systems, databases, etc.

Some operating systems use separate address spaces in the form of a range of virtual addresses that the operating system assigns to a user or separately running program. Each user may have its own address space and this maintains a distinction between programs and data belonging to each address space. Cross-memory communication allows a program in one address space to communicate with a program in another address space. A program call instruction may be used to call a program in another address space. Cross-memory communication may be coordinated through operating system security controls.

The described method may use such cross-memory communication to call a code component of a program that resides in a different memory, such as a different address space. Equivalent cross-memory communication may be used in other forms of operating systems that use equivalents to address spaces. For example, in other operating systems, processes for performing tasks may have many “threads” of execution and inter-process communication is possible. This is commonly used for process synchronization, but may equally well be used in the same way as cross-memory communication. These different types of communication are referred to as cross-version communication.

The component sharing tool 110 provides a mechanism for allowing the second version 130 to operate using a code component 121 of the first version 120. This may be used to avoid the use of a faulty code component 131 in the second version 130, or where a code component is not available in the second version 130. Instead of using a code component 131 of the second version 130, the shared code component 121 of a first version 120 is called by the component sharing tool 110. This enables the second version 130 to operate, for example, for debugging or fault correction purposes.

The component sharing tool 110 may be used when the second version 130 contains code changes which are causing problems. The component sharing tool 110 enables the second version of the product to use one or more shared components 121 of a first version 120 of the product which does not contain the code changes which are causing problems. In some instances, the first version 120 is a working version of the product and the second version 130 is a non-working version.

The component sharing tool 110 is configured to define which functions are to be performed by the first version 120 on behalf of the second version 130.

The code component sharing is an improvement in the technical field of computer software development and maintenance generally and more particularly in the technical field of computer software fault analysis and debugging.

An example problem occurs where changes to a software product cause the product to have severe problems such that it may not initialize properly. Under these circumstances, it can be difficult to gather diagnostic information required to debug the problem. One version of a software product that provides a process and that is not working properly can use one or more components of another version of the product. This may be used where the other version does not contain the code changes which are causing problems in the process.

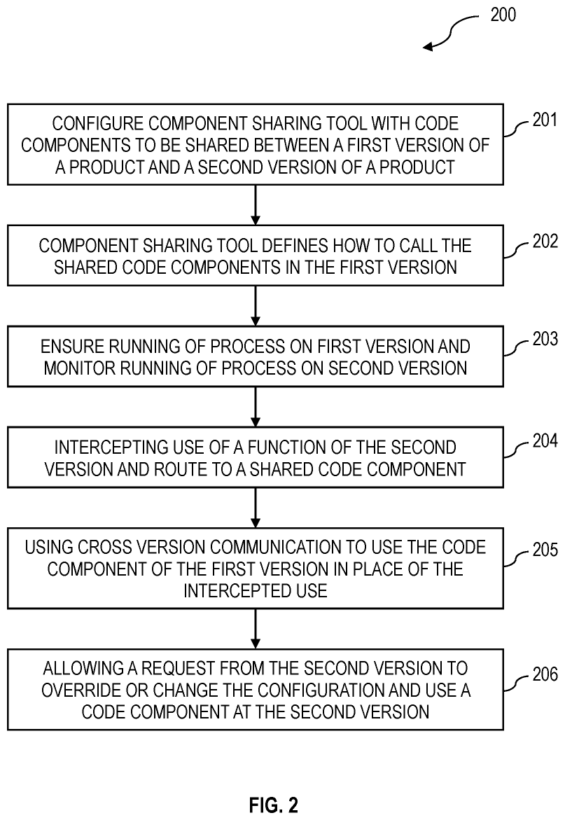

Referring to FIG. 2, a flow diagram 200 shows an example embodiment of the described method for code component sharing across software product versions for fault handling.

The method includes configuring 201 a component sharing tool to define one or more shared code components for functions of a first version of a product to be used by a second version of the product for the functions in the second version. The use of the shared code components may be instead of equivalent code components in the second version that are defective or missing. The equivalent code components may be updated versions of the code components. A shared code component may be a domain or functional area to be run in the first version of the product. For example, the component sharing tool may be configured such that a messaging domain is to be run in the first version and therefore any messages in the second version may be intercepted and rerouted to be issued from the first version.

The method may include the component sharing tool looking up and defining 202 how to call the shared code components that are configured to be used from the first version. For example, to invoke a message domain in the first version of a product, the second version needs to know the address of the message domain in the first version. This enables the component sharing tool to route an “issue message” request from the second version to the first version's message domain.

The method may ensure a running of a process on the first version of the product and may monitor 203 a running of a process on the second version of the product.

The method may intercept 204 a use of a function of the second version equivalent to a function of a shared code components for which the component sharing tool has been configured and may route the intercepted use to the shared code component of the first component.

When a code component for a function is invoked, control is typically passed to code at an address in a table of some sort, for example, a domain anchor table. Interception 204 and routing may entail changing the relevant address in the table so as to pass control to the code sharing tool, which will know where to route the request inside the first version of the product.

The method may use 205 cross-version communication of a shared operating system of the first and second versions of the product, to use the shared code component of the first version in place of the intercepted use. The cross-version communication may be cross-memory communication to use cross memory calls from a version in one address space to a version in another address space to use the code component on the first version in place of the intercepted use. Alternatively, the cross-version communication may use inter-process communication.

The method may allow 206 a request from the second version to reconfigure a shared code component, for example, to use an equivalent code component at the second version. For example, this may be allowed when the equivalent code component at the second version needs to be tested.

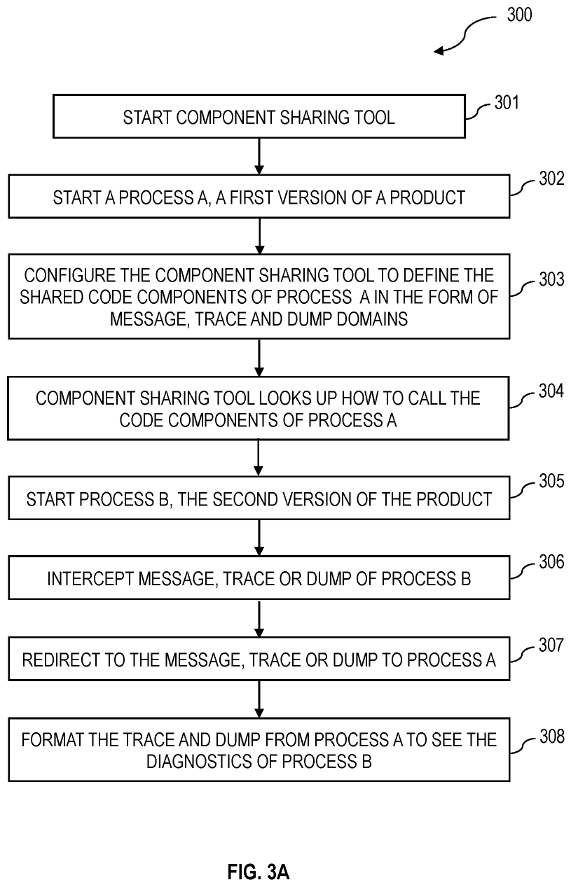

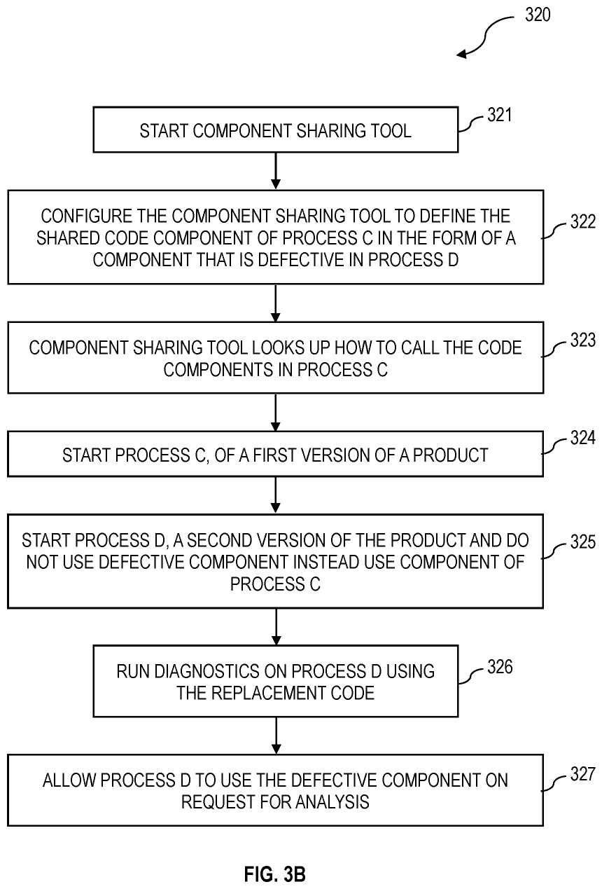

Referring to FIG. 3A, a flow diagram 300 shows an example embodiment of the described method where a software product contains code that requires debugging. Process A is an instance of a product that is stable. Process B is another instance of the product that contains code that requires debugging. The flow of FIG. 3A uses a sequence of events to obtain diagnostic information for Process B.

The component sharing tool is started 301 that will enable the processes to share component usage. Process A is started 302, which is a version of a product which runs normally.

The component sharing tool is configured 303 by instructing the tool as to which code functions in Process A are to be shared for Process B. For example, the tool may be configured so that Process B may use message, trace, and dump domains from Process A. Process B may not have existing trace and dump domains and so it needs to share those of Process A. The component sharing tool may look up 304 how to call the configured shared code components of Process A.

Process B may be started 305, which is another version of the product that is defective. Use of the configured code components of Process B may be intercepted 306. The configured code components of Process B may be redirected 307 to Process A. In this example, use of message, trace, or dump components in Process B may be intercepted 306 and redirected 307. If a message needs to be issued in Process B, the message code of Process A is used. Similarly, if a trace needs to be issued in Process B, the trace code of Process A is used for trace. If Process B fails, the dump domain of Process A is used.

The method may format 308 results from the use of the code component of Process A. The method may format a trace and dump from Process A to see the diagnostics produced by the Process B version.

Referring to FIG. 3B, a flow diagram 320 shows another example embodiment of the described method where a software product contains code that is defective. The component sharing tool enables a defective version of a product, Process D to use any other component(s) from another non-defective version of the product, Process C. In this example, it is assumed that there is a problem with temporary storage that is causing a system running Process D to fail soon after initialization. A typical sequence of events may then be as follows.

The component sharing tool may be started 321, which will enable the Processes C and D to share component usage. The component sharing tool may be configured 322 to use a code component in the problem free version of the product, Process C, instead of an equivalent code component that is defective in Process D. In this example, the defective code in Process D is the temporary storage function. The component sharing tool may look up 323 how to call the code component of Process C, for example, the temporary storage function of Process C.

The method may start 324 Process C. The method may then start 325 Process D. Process D will not use its defective component, in this case its own local temporary storage code, but will instead use the code component of Process C, in this case the temporary storage in Process C.

The method may enable the running 326 of diagnostics on Process D whilst using the alternative to the defective code component. In the example, once Process D has initialized, it may then be possible to attempt to determine what is wrong. This may determine if the fault is purely within the defective code, for example, the temporary storage. Trace options, test programs etc. may be installed in Process D.

The method may allow 327 Process D to use its own defective code (for example, temporary storage) on request. This may override or change the configuration at the component sharing tool. This may allow more investigations to be performed which would help to determine the source of a problem in the defective code.

In a further example embodiment, the second version may be a product under development that may want to use a function, such as to issue a message. The second version will code a function call to issue the message. However, if the message issuing function does not yet exist in the second version, the call may be intercepted and routed to a first version of the product where the message issuing code does exist.

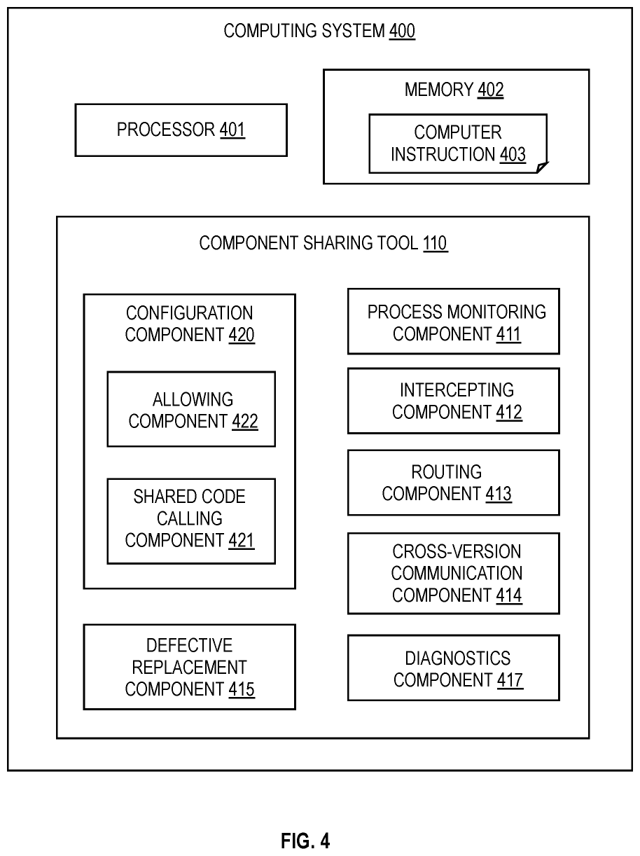

Referring to FIG. 4, a computing system 400 is shown which may provide an example environment to run the component sharing tool 110. The first and second product versions may also run on the computing system 400 or may be accessed remotely.

The computing system 400 may include at least one processor 401, a hardware module, or a circuit for executing the functions of the described components which may be software units executing on the at least one processor. Multiple processors running parallel processing threads may be provided enabling parallel processing of some or all of the functions of the components. Memory 402 may be configured to provide computer instructions 403 to the at least one processor 401 to carry out the functionality of the components.

The component sharing tool 110 may include a configuration component 420 for configuring one or more shared code components for functions of a first version of a product to be used by a second version of the product for the functions in the second version. The configuration component 420 may include a shared code calling component 421 for defining how to call the shared code components that are configured to be used from the first version when required by an intercepted use.

The configuration component 420 may include an allowing component 422 for allowing a request from the second version to use the one or more code components overriding or changing the configuration of a use of the shared code components, for example to test an equivalent code component at the second version.

The component sharing tool 110 may include a process monitoring component 411 for ensuring a running of a process on the first version of the product and monitoring a running of a process on the second version of the product.

The component sharing tool 110 may include an intercepting component 412 for intercepting use of a function of the second version equivalent to a function of a shared code component of the first version. The component sharing tool 110 may include a routing component 413 for routing the intercepted use to the shared code component of the first version.

The component sharing tool 110 may include a cross-version communication component 414 for using cross-version communication between the first and second versions to use a shared code component on the first version in place of the intercepted use. For example, this may use cross memory calls from one address space to another address space to use a shared code component on the first version in place of the intercepted use. This may use cross memory services and communication of the product versions. Alternatively, this may use inter-process communication between the product versions.

The component sharing tool 110 may include a diagnostics component 417 for formatting diagnostics from the first version to see diagnostics produced by the second version.

The one or more code components of the second version may be defective code components in the second version of the product and the component sharing tool 110 may include a defective replacement component 415 for using the one or more shared code components of the first version in place of one or more defective code components of the second version in order to install trace or test programs on the second version.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

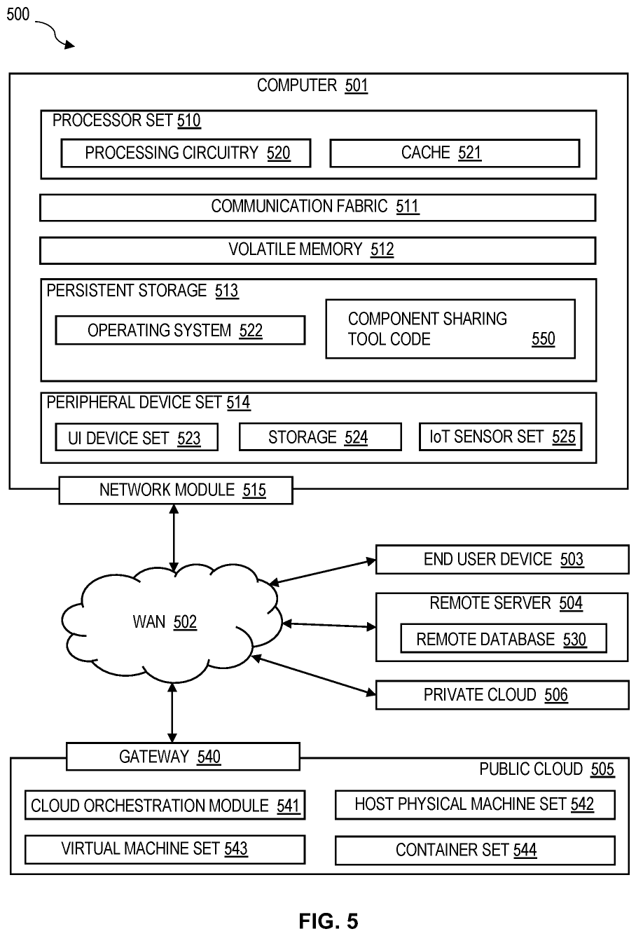

In FIG. 5, computing environment 500 contains an example of an environment for the execution of at least some of the computer code involved in performing the inventive methods, such as component sharing tool code 550. In addition to block 526, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 526, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 526 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in block 526 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for code component sharing across software product versions for product development, the method comprising:
configuring one or more shared code components for functions of a first version of a product to be used by a second version of the product for the functions in the second version;
intercepting a use of a function of the second version equivalent to a function of a shared code component of the first version;
routing intercepted use to the shared code component of the first version; and
using cross-version communication of a shared operating system between the first version and the second version to use the shared code component on the first version for the intercepted use of the function.

2. The computer-implemented method of claim 1, further comprising:
defining how to call the one or more shared code components that are configured to be used from the first version when required by the intercepted use.

3. The computer-implemented method of claim 1, further comprising:
allowing a request from the second version to use equivalent one or more code components at the second version overriding or changing a configuration.

4. The computer-implemented method of claim 1, further comprising:
ensuring a running of a process on the first version of the product; and
monitoring a running of a process on the second version of the product for use of a function of the second version equivalent to a function of a configured shared component of the first version.

5. The computer-implemented method of claim 1, wherein the one or more shared code components of the first version are used in debugging the second version.

6. The computer-implemented method of claim 5, wherein the one or more shared code components are message, trace, and dump code components; and the computer-implemented method further including formatting a trace and dump from the first version to see diagnostics produced by the second version.

7. The computer-implemented method of claim 1, wherein a shared code component of the first version is equivalent to a defective code component of the second version, and the computer-implemented method further including: using the one or more shared code components of the first version in order to install trace options or test programs on the second version.

8. The computer-implemented method of claim 7, further including:
requesting use of the defective code component of the second version to test it.

9. The computer-implemented method of claim 1, wherein a shared code component of the first version is equivalent to a missing code component of the second version.

10. The computer-implemented method of claim 1, wherein the cross-version communication is cross-memory communication or inter-process communication of the shared operating system of the first and second versions of the software product.

11. A computer system for code component sharing across software product versions for product development, comprising:
a processor and a memory configured to provide computer program instructions to the processor to execute functions of components of a component sharing tool provided on a shared operating system of a first and second version of a software product, the component sharing tool including:
a configuration component for configuring one or more shared code components for functions of a first version of a product to be used by a second version of the product for the functions in the second version;
an intercepting component for intercepting a use of a function of the second version equivalent to a function of a shared code component of the first version;
a routing component for routing intercepted use to the shared code component of the first version; and
a cross-version communication component for using cross-version communication of a shared operating system between the first version and the second version to use the shared code component on the first version for the intercepted use of the function.

12. The computer system of claim 11, further comprising a shared code calling component for defining how to call the one or more shared code components that are configured to be used from the first version when required by the intercepted use.

13. The computer system of claim 11, further comprising an allowing component for allowing a request from the second version to use equivalent one or more code components at the second version overriding or changing a configuration.

14. The computer system of claim 11, further comprising a process monitoring component for ensuring a running of a process on the first version of the product and monitoring a running of a process on the second version of the product for use of a function of the second version equivalent to a function of a configured shared component of the first version.

15. The computer system of claim 11, wherein the one or more code shared components of the first version are used in debugging the second version of the product.

16. The computer system of claim 15, wherein the one or more shared code components are message, trace, and dump code components; and the computer system further including a diagnostics component for formatting a trace and dump from the first version to see diagnostics produced by the second version.

17. The computer system of claim 11, wherein a shared code component of the first version is equivalent to a defective code component of the second version, and the computer system further including using the one or more shared code components of the first version in order to install trace options or test programs on the second version.

18. The computer system of claim 11, wherein one or more code components of the second version are defective code components in the second version of the product; and the computer system including a defective replacement component for using the one or more shared code components of the first version in place of the one or more defective code components of the second version in order to install trace or test programs on the second version.

19. The computer system of claim 11, wherein the cross-version communication is cross-memory communication or inter-process communication of the shared operating system of the first and second versions of the software product.

20. A computer program product for code component sharing across software product versions for product development, the computer program product comprising a computer readable storage medium having program instructions embodied therewith, the program instructions executable by a processor to cause the processor to:
configure one or more shared code components for functions of a first version of a product to be used by a second version of the product for the functions in the second version;
intercept a use of a function of the second version equivalent to a function of a shared code component of the first version;
route intercepted use to the shared code component of the first version; and
use cross-version communication of a shared operating system between the first version and the second version to use the shared code component on the first version for the intercepted use of the function.
